(19) United States
(12) Patent Application Publication
(10) Pub. No.: US 2021/0204018 A1
(43) Pub. Date: Jul. 1, 2021

(54) CONTENT DISTRIBUTION SYSTEM USING BROADCAST NETWORK

(71) Applicants: DIGICAP CO., LTD., Seoul (KR); MARUENG CO., LTD., Daejeon (KR)

(72) Inventors: Joon Young PARK, Seoul (KR); Woo Chul LEE, Daejeon (KR)

(73) Assignees: DIGICAP CO., LTD., Seoul (KR); MARUENG CO., LTD., Daejeon (KR)

(21) Appl. No.: 17/134,297

(22) Filed: Dec. 26, 2020

Related U.S. Application Data
(60) Provisional application No. 62/954,158, filed on Dec. 27, 2019.

(51) Int. Cl. H04N 21/433; H04N 21/61; H04L 29/08; H04N 21/643; H04L 29/06

(52) U.S. Cl. CPC H04N 21/4331; H04N 21/6125; H04L 69/08; H04N 21/643; H04L 67/1097

(57) ABSTRACT

Provided is a content caching broadcast transmission system that receives content from a content server, converts the content, and transmits the content through a non-real-time broadcast protocol. A receiver receives broadcast content through the non-real-time broadcast protocol, converts the broadcast content into web content, stores the web content, and forwards the web content to a client terminal in a unicast manner. The web content may be an Internet application package including a plurality of web documents and a series of scripts necessary for playback. A web object included in the Internet application package may be parsed, and addresses of links included in the web object may be converted such that the addresses are accessible in a receiver and then may be transmitted.

### TECHNICAL FIELD

Disclosed is a technique that delivers digital content and in particular interactive digital content through broadcast Internet.

### DESCRIPTION OF THE RELATED ART

Although online education is becoming commonplace, there are still people who have limited broadband Internet access. Korean Patent No. 1,358,689 discloses a technique in which set-top boxes receive and store split files of content from content providing servers and in which a set-top box that is appropriately selected under the control of a service management server provides a requested split file in response to a content delivery request from client terminals. However, this technique may limit service when communication between content providing servers and set-top boxes is not smooth.

### DISCLOSURE

### Technical Problem

The proposed invention is directed to providing a content distribution system capable of transmitting a large amount of content to a client terminal in an environment where Internet access is restricted.

Furthermore, the proposed invention is directed to providing a content distribution system capable of transmitting a large amount of interactive content to a client terminal in an environment where Internet access is restricted.

### Technical Solution

According to an aspect of the proposed invention, there is provided a content caching broadcast transmission system that receives web content from a content server, converts the web content into broadcast content, and transmits the broadcast content through a non-real-time broadcast protocol. A receiver receives broadcast content through the non-real-time broadcast protocol, converts the broadcast content into web content, stores the web content, and forwards the web content to a client terminal in a unicast manner.

According to an additional aspect, content may be an Internet application package including a plurality of web documents and a series of scripts necessary for playback.

According to an additional aspect, a web object included in the Internet application package may be parsed, and addresses of links included in the web object may be converted such that the addresses are accessible in a receiver and then may be transmitted.

According to an additional aspect, receiver service information may be managed in the cloud. The receiver service information may include at least one of access information including a network address of the receiver, information on a wireless channel with which the receiver is synchronized, and media transmission service protocol information of the receiver.

### Advantageous Effects

According to the proposed invention, Internet content is transmitted to a receiver installed at home through a broadcast network. Content may be served on the basis of Internet application packages used by users. An Internet application package is prepared so that a client can access the Internet application package in a receiver through a minimum number of external network accesses. Access information is managed in the cloud despite dynamic address allocation, and a client terminal can always immediately access the receiver.

### BRIEF DESCRIPTION OF THE DRAWINGS

FIG. 1 shows a configuration of a content distribution system according to an embodiment of the proposed invention.

FIG. 2 is a block diagram showing a configuration of a content caching broadcast transmission system according to an embodiment.

FIG. 3 is a block diagram showing a configuration of a home content service apparatus according to an embodiment.

### DETAILED DESCRIPTION OF THE EMBODIMENTS

The above or other aspects will be implemented through embodiments described with reference to the accompanying drawings. It is to be understood that elements in each embodiment can be variously combined with other elements in the corresponding embodiment or elements in other embodiments unless otherwise stated or as long as there is no contradiction therebetween. Based on the principle that the inventor can properly define the concepts of terms in order to describe his or her own invention in the best way, terms used in the specification and claims should be interpreted as having meanings and concepts consistent with the following description or the proposed technical spirit. Hereinafter, exemplary embodiments of the present invention will be described in detail with reference to the accompanying drawings.

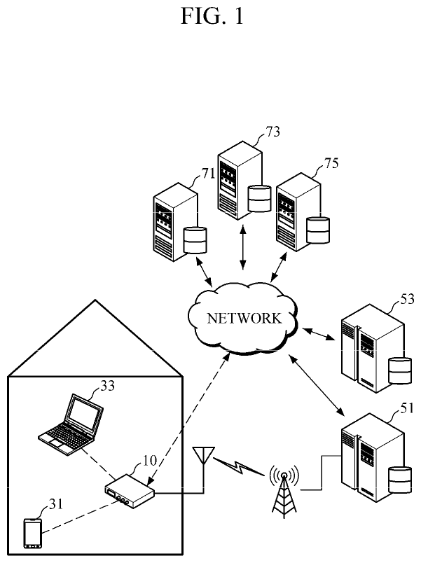

FIG. 1 shows a configuration of a content distribution system according to an embodiment of the present invention. The content distribution system according to an embodiment includes a content caching broadcast transmission system 51 configured to provide content delivery service and a home content service apparatus installed at home.

According to an aspect of the proposed invention, the content caching broadcast transmission system accesses multiple content servers 71, 73, and 75 over an Internet network, receives web content, converts the web content into broadcast content, and stores the broadcast content. The content caching broadcast transmission system transmits the broadcast content through a non-real-time broadcast protocol. For example, the content caching broadcast transmission system may transmit the broadcast content through a non-real-time transmission (NRT) protocol defined in the Advanced Television Systems Committee (ATSC) 3.0 standard through a terrestrial network. Here, the NRT protocol is not limited to the NRT protocol of the ATSC 3.0 standard and may be any standard related to non-real-time data transmission among broadcast protocols. In the ATSC 3.0 standard, the content transmission network may include, for example, a software-defined modulator installed in a base station and a software-defined radio head installed at home.

The content caching broadcast transmission system transmits content through the non-real-time broadcast protocol at night when a real-time broadcast is interrupted or bandwidth is available. The home content service apparatus receives broadcast content through the non-real-time broadcast protocol of the terrestrial network, decodes the broadcast content into web content, and stores the web content. Upon a request of a client terminal, the home content service apparatus forwards requested content in a unicast manner. The client terminal is in an environment where broadband Internet access is restricted but may receive content stored and prepared by the home content service apparatus overnight. The client terminal may be, for example, a mobile device such as a smartphone 31, an information device equipped with a web browser such as a computer 33, or a broadcast receiver such as a TV or a set-top box.

[Description of Invention of claims 1, 2, 3, and 8]

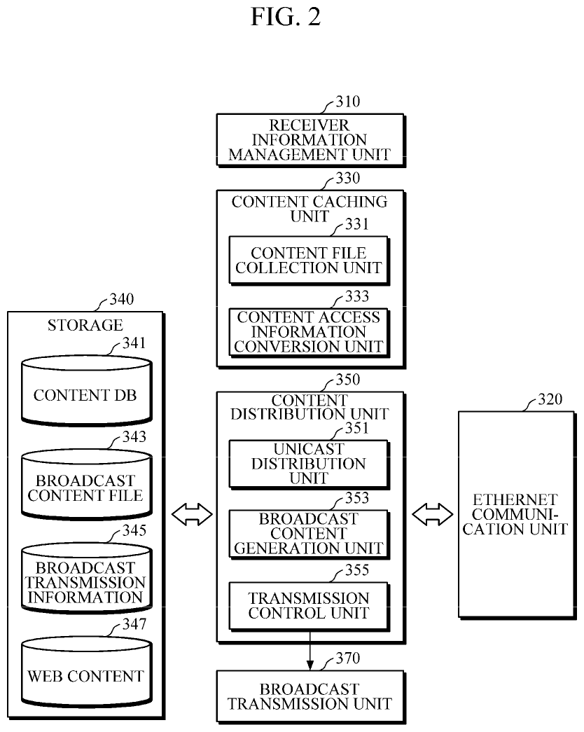

FIG. 2 is a block diagram showing a configuration of a content caching broadcast transmission system according to an embodiment. As shown, the content caching broadcast transmission system according to an embodiment includes a broadcast transmission unit 370, an Ethernet communication unit 320, a storage 340, a content caching unit 330, and a content distribution unit 350. The broadcast transmission unit 370 transmits a broadcast stream to multiple receivers through a terrestrial network. In the shown embodiment, the broadcast transmission unit 370 may transmit broadcast content through the NRT protocol defined in the ATSC 3.0 standard. To this end, the broadcast transmission unit 370 provides an NRT application program interface (API) that may be called by an application program. The NRT API controls a multiplier and signaling conforming to the ATSC 3.0 standard through an NRT server.

The Ethernet communication unit 320 is configured to connect to a content server through an Ethernet protocol. The storage 340 stores broadcast transmission information, broadcast content, and web content received from the content server. For example, the storage 340 may be implemented as a single or distributed network storage.

The content caching unit 330 receives a web content file from content servers through the Ethernet communication unit 320 and stores the received web content file. The content caching unit 330 may collect web content located at a predetermined specific uniform resource locator (URL) of the content servers determined in advance.

According to an aspect, the web content may be one Internet application package. Here, an Internet application package refers to a set of pieces of digital content forming one piece of content as a whole. For example, in the case of a video lecture, a lecture video file, a script or commands that control the playback of the lecture video file, a textbook content file, and metadata interoperate with each other to form one piece of content as a whole. File objects inside the Internet application package may include URL links that refer to each other. Also, the file objects inside the Internet application package may include links to external web resources different from content, such as links to advertisement information or shopping information.

According to an additional aspect, the content caching unit 330 may include a content file collection unit 331 and a content access information conversion unit 333. The content file collection unit 331 accesses a content server through an Internet communication unit and receives file objects related to one Internet application package. For example, the content file collection unit 331 may collect file objects related to one Internet application package by acquiring and parsing a file object located at the main URL of the content, accessing URL links adjacent to the main URL among URL links included in the file object, and acquiring file objects located at the URL links. Whether two URLs are adjacent to each other can be determined based on, for example, whether higher-level information, i.e., a server IP address or one or more parent folder names, in one URL matches that in the other URL.

The content access information conversion unit 333 parses a file object included in the Internet application package and converts addresses of links included in the file object such that the addresses are accessible in the receiver. The Internet application package collected by the content caching unit 330 is downloaded into the receiver, that is, a home content service apparatus according to an aspect of the proposed invention, and then is served to a client terminal. For a client terminal with limited broadband Internet access, it may be important to allow any Internet application package to be served to the client terminal even through a home content service apparatus alone. While the Internet application package is downloaded into the home content service apparatus and stored in the memory, the content access information conversion unit 333 converts links included in the file objects included in the Internet application package such that the links refer to the file objects download together with the links. Such link conversion may be performed, for example, by substituting a description of higher-level information, i.e., one or more parent folders in a URL, with a specific folder name of the home content service apparatus. The content access information conversion unit may convert file objects included in such an Internet application package into, for example, one compressed file.

The content distribution unit 350 converts a content file stored in the content caching unit 330 into broadcast content and transmits the broadcast content through the broadcast transmission unit 370 according to a non-real-time broadcast protocol. In an embodiment, the content distribution unit 350 may include a broadcast content generation unit 353 and a transmission control unit 355. The broadcast content generation unit 353 converts web content that is collected and converted by the content caching unit 330 and stored in a content database 341 of the storage 340 and, in the shown embodiment, content in which the file objects included in the Internet application package are compressed into one file into broadcast content, and stores the broadcast content in a broadcast content file database 343 and a broadcast transmission information database 345. The broadcast content file is information to be transmitted through the NRT protocol. In addition to the broadcast content file, the broadcast content generation unit 353 determines a schedule for the transmission of the broadcast content file to generate schedule information and generates signaling information necessary for the transmission. Then, the broadcast content generation unit 353 stores these pieces of information in the broadcast transmission information database 345. For example, the broadcast content is configured such that a different piece of broadcast content is transmitted for each subscriber segment, and segment information may be included in the signaling information.

According to an additional aspect, the broadcast content generation unit 353 allocates a corresponding piece of web content to each channel to form a channel map, converts the corresponding piece of web content into broadcast content, and generates the signaling information. Channel map information may be stored in the broadcast transmission information database 345.

The transmission control unit 355 controls the broadcast transmission unit 370 to transmit the broadcast content file read from the broadcast content file database 343 and the signaling information read from the broadcast transmission information database 345 according to the schedule information stored in the broadcast transmission information database 345.

[Description of Invention of claims 4 and 5]

According to an additional aspect, receiver service information may be managed in the cloud. The content caching broadcast transmission system according to an embodiment may further include a receiver information management unit 310. The receiver information management unit 310 receives receiver service information from a receiver, registers the receiver service information, and provides the receiver service information upon a request from a client terminal. In the embodiment shown in FIG. 1, the receiver information management unit 310 is implemented in one server as a part of the content caching broadcast transmission system. However, the present invention is not limited thereto, and the receiver information management unit 310 may be implemented in a cloud computer separate from a server computer in which the elements shown in FIG. 2 are implemented. In an embodiment, information regarding client terminals that can access one receiver is managed. When one client terminal requests the receiver service information, the receiver information management unit 310 identifies a receiver which the client terminal can access and provides service information registered by the corresponding receiver.

According to an additional aspect, the receiver service information may include access information including a network address of the receiver. The access information may include a device name and an Internet protocol (IP) address. For example, it is assumed that a dynamic address is allocated to the receiver according to a protocol such as the Dynamic Host Configuration Protocol (DHCP). The receiver transmits an IP address that is newly allocated when the apparatus is powered or initialized to the receiver information management unit 310 of the content caching broadcast transmission system to register the IP address. The client terminal requests and receives the access information from the receiver information management unit 310 of the content caching broadcast transmission system in order to find the receiver in a home network. Thus, the client terminal can always quickly find and access the receiver in the home network.

[Description of Invention of claim 6]

According to an additional aspect, the receiver service information may include wireless channel information synchronized with a transmission channel of the receiver. The receiver, which has received and stored web content cached in the content caching broadcast transmission system, may forward the stored web content to a client terminal, e.g., a TV, through a wireless transmission channel. The receiver delivers, to the receiver information management unit 310 of the content caching broadcast transmission system, the wireless channel information transmitted when the apparatus is powered or initialized. In order to receive web content from the receiver, an application program of the client terminal, e.g., a TV, requests and receives, from the receiver information management unit 310 of the content caching broadcast transmission system, frequency information for synchronization with the wireless channel through which the transmission is performed by the receiver. Thus, the client terminal can always quickly receive content transmitted by the receiver.

According to an additional aspect, the receiver service information may include media transmission service protocol information of the receiver. The receiver may deliver a plurality of media transmission service protocol streams through one wireless transmission channel. For example, the receiver may selectively transmit an HTTP Live Streaming (HLS) protocol stream and an MPEG-Dynamic Adaptive Streaming over HTTP (MPEG-DASH) protocol stream through one wireless transmission channel. The receiver delivers, to the receiver information management unit 310 of the content caching broadcast transmission system, the media transmission service protocol information in which content is transmitted through a wireless channel specified by the receiver when the apparatus is powered or initialized, to register the media transmission service protocol information. In order to receive web content from the receiver, an application program of the client terminal, e.g., a TV, requests and receives the media transmission service protocol information transmitted through the wireless channel, through which the receiver performs transmission, from the receiver information management unit 310 of the content caching broadcast transmission system. Thus, the client terminal can always quickly receive content transmitted by the receiver.

[Description of Invention of claim 7]

According to an additional aspect, the content caching broadcast transmission system may further include a unicast distribution unit 351. When a user requests a content file located in an external link, for example, in the content server 71 specified in FIG. 1, while the client terminal receives an Internet application package from the receiver and browses or plays back the Internet application package, the corresponding file may be acquired from the content caching broadcast transmission system by URL redirection. The unicast distribution unit 351 may access and provide the content file requested from the client terminal to a corresponding location of the web content storage 347 of the storage 340 by the URL redirection.

[Description of Invention of claim 9]

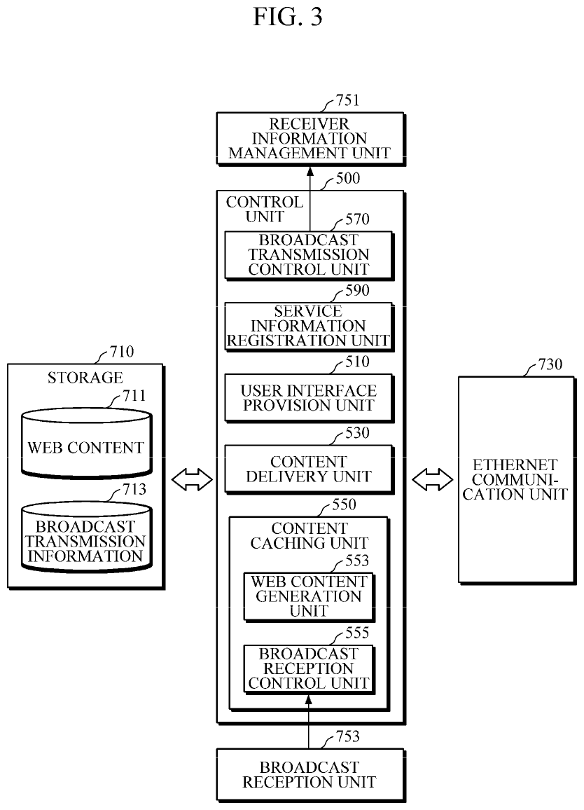

FIG. 3 is a block diagram showing a configuration of a home content service apparatus according to an embodiment. The home content service apparatus according to the shown embodiment corresponds to a receiver that receives, through a non-real-time broadcast protocol, content transmitted from the content caching broadcast transmission system described above with reference to FIG. 2. According to an aspect, the home content service apparatus includes a broadcast reception unit 753, an Ethernet communication unit 730, a memory 710, a content caching unit 550, a user interface provision unit 510, and a content transmission unit 530.

The broadcast reception unit 753 receives a broadcast stream through a terrestrial network. In the shown embodiment, the broadcast reception unit 753 may receive and decode broadcast content transmitted according to the NRT protocol defined in the ATSC 3.0 standard. The broadcast reception unit 753 receives a multiplexed broadcast stream, de-multiplexes the broadcast stream, and separates broadcast content and control information. For example, the broadcast content delivered through the NRT protocol is parsed by an NRT parser, converted into web content, and stored in the memory 710. In this case, when the parsed file is a compressed file, a process of decompressing the compressed file to extract a plurality of object files may be further included. The control information may be parsed by another parser, for example, an SLT parser in the ATSC 3.0 standard, to extract playback control information such as channel map information.

The Ethernet communication unit 730 forwards a content file through connection to the client terminal through an Internet protocol. The memory 710 stores the control information and the web content extracted from the broadcast content received by the broadcast reception unit 753.

The content caching unit 550 stores web content decoded through the broadcast reception unit 753 in the memory 710. Additionally, the content caching unit 550 may store playback control information decoded through the broadcast reception unit 753 in the memory 710.

The user interface provision unit 510 provides a web-based graphical user interface to a media terminal accessed through the Ethernet communication unit 730 and receives a user's instruction through the graphical user interface. For example, the user interface provision unit 510 may provide a web document-based graphical user interface suitable for the media terminal. The graphical user interface may include buttons which are for receiving user instructions and a region where a media file is played back.

The content transmission unit 530 reads, from the memory 710, a file of web content to be played back by an instruction received through the user interface provision unit 510 and streams the file to the client terminal accessed through the Ethernet communication unit 730 in a unicast manner.

[Description of Invention of claim 10]

According to an additional aspect, the home content service apparatus may further include a service information registration unit 590. When the apparatus is initialized, the service information registration unit 590 transmits service information of the apparatus to a management server through the Ethernet communication unit 730 and registers the service information. For example, the management server may be the content caching broadcast transmission system shown in FIG. 1. As another example, the management server may be a separate cloud server independent from the server computer in which the content caching broadcast transmission system is implemented.

The service information registered by the service information registration unit 590 may be provided to the client terminal upon a request from the client terminal.

[Description of Invention of claim 11]

According to an additional aspect, the service information may include access information including a network address of the home content service apparatus. The access information may include a device name and an IP address. For example, when a dynamic address is allocated to the home content service apparatus according to a protocol such as the DHCP, the home content service apparatus transmits, to the management server, an IP address which is newly allocated when the apparatus is powered or initialized, to register the IP address. The client terminal requests and receives the access information from the management server in order to find the home content service apparatus in the home network. Thus, the client terminal can always quickly find and access the home content service apparatus in the home network.

[Description of Invention of claim 12]

According to an additional aspect, the home content service apparatus may further include a broadcast transmission unit 751 configured to transmit web content according to a broadcast protocol. For example, a client terminal to which content is served from the home content service apparatus may be a broadcast receiver such as a TV or a set-top box. The broadcast receiver may be synchronized with a wireless transmission channel of the home content service device to receive the broadcast content transmitted by the broadcast transmission unit 751.

[Description of Invention of claim 13]According to an additional aspect, the service information may include information on the wireless channel with which a transmission channel of the broadcast transmission unit 751 is synchronized. The home content service apparatus transmits wireless channel information transmitted when the apparatus is powered or initialized to the media management server to register the wireless channel information. In order to receive web content from the home content service apparatus, an application program of the client terminal, e.g., a TV, requests and receives, from the management server, frequency information for synchronization with the wireless channel through which the transmission is performed by the broadcast transmission unit 751. Thus, the client terminal can always quickly receive content transmitted by the home content service apparatus.

According to an additional aspect, the service information may include media transmission service protocol information of the broadcast transmission unit 751. The broadcast transmission unit 751 may transmit a plurality of media transmission service protocol streams through one wireless transmission channel. For example, the broadcast transmission unit 751 may selectively transmit an HLS protocol stream and an MPEG-DASH protocol stream through one wireless transmission channel. The home content service apparatus delivers, to the management server, media transmission service protocol information in which content is transmitted through a wireless channel specified by the apparatus when the apparatus is powered or initialized, to register the media transmission service protocol information. In order to receive web content from the home content service apparatus, an application program of the client terminal, e.g., a TV, requests and receives, from the management server, media transmission service protocol information transmitted through the wireless channel through which the transmission is performed by the home content service apparatus. Thus, the client terminal can always quickly receive content transmitted by the home content service apparatus.

The present invention has been described above with reference to embodiments referring to the accompanying drawings, but is not limited thereto. Rather, the present invention should be construed as encompassing various modifications that may be apparent to those skilled in the art. The appended claims are intended to cover such modifications.

### DESCRIPTION OF REFERENCE NUMERALS

10: home content service apparatus

31: smartphone

33: computer

51: content caching broadcast transmission system

53: service management server

71,73,75: web content server

310: receiver information management unit

320: Ethernet communication unit

330: content caching unit

331: content file collection unit

333: content access information conversion unit

340: storage

341: content DB

343: broadcast content file

345: broadcast transmission information

347: web content

350: content distribution unit

351: unicast distribution unit

353: broadcast content generation unit

355: transmission control unit

370: broadcast transmission unit

500: control unit

510: user interface provision unit

530: content delivery unit

550: content caching unit

553: web content generation unit

555: broadcast reception control unit

570: broadcast transmission control unit

590: service information registration unit

710: memory

711: web content

713: broadcast transmission information

730: Ethernet communication unit

751: broadcast transmission unit

753: broadcast reception unit

1. A content caching broadcast transmission system comprising:
a broadcast transmission unit configured to transmit a broadcast stream to multiple receivers through a terrestrial network;
an Ethernet communication unit configured to connect to a content server through an Ethernet protocol;
a storage;
a content caching unit configured to receive web content from content servers through the Ethernet communication unit and store the web content in the storage; and
a content distribution unit configured to convert the web content stored in the content caching unit into broadcast content and transmit the broadcast content through the broadcast transmission unit according to a non-real-time broadcast protocol.

2. The content caching broadcast transmission system of claim 1, wherein the web content is one Internet application package.

3. The content caching broadcast transmission system of claim 2, wherein the content caching unit comprises:
a content file collection unit configured to access the content server through an Internet communication unit and receive file objects related to one Internet application package; and
a content access information conversion unit configured to parse a file object included in the Internet application package and covert addresses of links included in the file object such that the addresses are accessible in a receiver.

4. The content caching broadcast transmission system of claim 1, further comprising a receiver information management unit configured to receive receiver service information from a receiver, register the receiver service information, and provide the receiver service information upon a request from a client terminal.

5. The content caching broadcast transmission system of claim 4, wherein the receiver service information managed by the receiver information management unit includes access information including a network address of the receiver.

6. The content caching broadcast transmission system of claim 4, wherein the receiver service information managed by the receiver information management unit includes information on a wireless channel synchronized with a transmission channel of the receiver and media transmission service protocol information of the transmission channel of the receiver.

7. The content caching broadcast transmission system of claim 1, further comprising a unicast distribution unit configured to provide a file object requested by uniform resource locator (URL) redirection to a client terminal through the Ethernet communication unit in a unicast manner.

8. The content caching broadcast transmission system of claim 1, wherein the content distribution unit comprises:
a broadcast content generation unit configured to allocate web content to each channel, form a channel map, convert the web content into broadcast content, and generate signaling information; and
a transmission control unit configured to control the broadcast transmission unit to multiplex and transmit the signaling information and the broadcast content for each channel.

9. A home content service device comprising:
a broadcast reception unit configured to receive and decode broadcast content forwarded through a terrestrial network according to a non-real-time broadcast protocol;
an Ethernet communication unit configured to access a client terminal through Ethernet communication;
a memory;
a content caching unit configured to store web content obtained through decoding by the broadcast reception unit in the memory;
a user interface provision unit configured to provide a web-based graphical user interface to a medial terminal accessed through the Ethernet communication unit and receive a user's instruction through the graphical user interface; and
a content transmission unit configured to read, from the memory, a file of web content to be played back by an instruction received through the user interface provision unit and stream the file to the client terminal accessed through the Ethernet communication unit in a unicast manner.

10. The home content service device of claim 9, further comprising a service information registration unit configured to transmit service information to a management server through the Ethernet communication unit to register the service information when the apparatus is initialized.

11. The home content service device of claim 10, wherein the service information includes access information including a network address of the apparatus.

12. The home content service device of claim 9, further comprising a broadcast transmission unit configured to transmit web content according to a broadcast protocol.

13. The home content service device of claim 12, wherein the service information includes information on a wireless channel synchronized with a transmission channel of the broadcast transmission unit and media transmission service protocol information of the transmission channel of the broadcast transmission unit.
